(19) United States
(12) Patent Application Publication
(10) Pub. No.: US 2024/0329203 A1
(43) Pub. Date: Oct. 3, 2024

(54) Lidar Device

(71) Applicant: Ball Photonics, Inc., Portland, OR (US)

(72) Inventors: Paul V. Braun, Champaign, IL (US); Peter D. Dragic, Champaign, IL (US); Joseph Bernhardt Geddes, III, Berkeley, CA (US); Lynford Goddard, Champaign, IL (US); Boris Kobrin, Portland, OR (US)

(21) Appl. No.: 18/442,735

(22) Filed: Feb. 15, 2024

Related U.S. Application Data
(60) Provisional application No. 63/447,105, filed on Feb. 21, 2023.

(51) Int. Cl. G01S 7/481; G01S 7/4911; G01S 7/4912; G01S 17/32; G01S 17/58

(52) U.S. Cl. CPC G01S 7/4811; G01S 7/4911; G01S 7/4912; G01S 17/32; G01S 17/58

(57) ABSTRACT

Light Detection and Ranging (LIDAR) device, which has a capability to enable position and speed detection with high signal-to-noise ratio. It is achieved by interrogating many targets/directions simultaneously. The device utilizes a ball lens and an array of light emitting and collecting elements distributed on and coupled to a ball lens; these elements could be gratings connected with a light processing chip with an array of waveguides; alternatively, it could be an array of VCSELs and light detector elements distributed on and coupled to a ball lens; and yet, another alternative is a spatial light modulators (SLMs) for frequency modulation for the transmitted beams. The distance and speed of a target is determined using FMCW signal processing scheme with signal frequency and intensity multiplexing.

### CLAIM OF PRIORITY

This application claims the priority benefit of U.S. Provisional Patent Application No. 63/447,105 filed Feb. 21, 2023, the entire disclosures of which are incorporated herein by reference.

### FIELD OF THE DISCLOSURE

The present disclosure relates to methods and devices for light detection and ranging (LiDAR).

### BACKGROUND

LiDAR (Light Detection and Ranging) is an active remote sensing method that works on the principle of radar but uses light waves sources instead of radio waves. Today most experts agree that LiDAR is one of the key sensing technologies required to enable partial to full autonomous driving. LiDAR is a tech that's sprouting up everywhere. Besides self-driving cars, or assisted driving, it is used in robotics and drones, smartphone cameras, and AR headsets.

Frequency-Modulated Continuous Wave (FMCW) LiDAR technology is capable, in principle, of measuring reflections from highly diffused surfaces (e.g, a Lambertian surface) located quite far away from the device. Unfortunately, reliability of detecting objects depends on many factors which are quite hard to satisfy simultaneously. Ultimately, the range and visibility offered by a LiDAR solution is determined by the power level and signal-to-noise ratio (SNR) of the system. The signal to noise ratio decreases with increasing distance, which seriously affects the retrieval accuracy of the LiDAR system. It increases with the laser power, but this parameter has some strong limitation related to eye safety of pedestrians and drivers.

Thus, a new solution is needed to provide LiDAR devices with high SNR ratio, keeping potential exposure of pedestrians and drivers to laser beams below acceptable level.

### SUMMARY

Embodiments according to the present disclosure provide a solution to significantly increase SNR at laser power below acceptable threshold level for safety. This is achieved by interrogating many targets/directions simultaneously using an array of lasers and light detectors distributed across the surface of a ball lens and connected to control electronics with an electrical conduit. Alternatively, laser sources and light detectors could be positioned remotely to the ball lens, and the light is transmitted to and from a ball lens using waveguides with light couplers. According to another embodiment, a special light modulator is used to perform frequency light modulation for the transmitted beams.

### BRIEF DESCRIPTION OF THE DRAWINGS

FIG. 1: General schematics of the proposed LiDAR device, showing an array of components arranged on the lens surface for transmitting and detecting light

FIG. 2: SNR calculations dependence on the number of directions interrogated at the same time

FIG. 3: Schematics of the proposed LiDAR device according to an embodiment, showing few different configurations of the ball lens

FIG. 4: Schematics of the proposed LIDAR device according to an embodiment, where an array of components occupies the hemisphere of the ball lens

FIG. 5: Schematics of the proposed LIDAR device according to an embodiment, where an array of components include laser diodes and light detectors

FIG. 6: Examples of VCSEL/light detector configurations

FIG. 7: Schematics of the proposed LiDAR device according to an embodiment, where an array of components include gratings and waveguides

FIG. 8: Example of grating coupler component

FIG. 9: Schematics of the embodiment with VCSEL/light detector coupled to a waveguide through grating coupler

FIG. 10: Schematics of the proposed LIDAR device according to an embodiment, showing spatial light modulator (SLM) wrapped around the ball lens

FIG. 11: Schematics of the proposed LIDAR device according to an embodiment, showing spatial light modulator (SLM) as a stand-alone component positioned between the source and the ball lens

FIG. 12: Schematic of a method for wrapping the component array around a ball lens

FIG. 13: Schematic of a method for transfer printing the component array layer to a flexible substrate for wrapping around the lens

FIG. 14: Schematic of a method for mass transfer process for assembly of the components on a flexible substrate or a ball lens

### DETAILED DESCRIPTION

Although the following detailed description contains many specific details for the purposes of illustration, anyone of ordinary skill in the art will appreciate that many variations and alterations to the following details are within the scope of the invention. Accordingly, the aspects of the disclosure described below are set forth without any loss of generality to, and without imposing limitations upon, the claimed invention.

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “first,” “second,” etc., is used with reference to the orientation of the figure(s) being described. Because components of embodiments of the present invention can be positioned in many different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

### Embodiment-I

Ball Photonics team proposes a new approach to building a high sensitivity FMCW LiDAR device whose system signal-to-noise ratio (SNR) can reach the shot noise limit. In this quantum-limited regime, the system can overcome noises that are prominent in other LiDAR types, such as flash LIDAR, which can deleteriously limit the range.

Although there are many potential ways to realize such a LiDAR, they all include the following:
light source;
modulation scheme;
means to direct light out of ball lens;
means to couple optical and/or electrical signals from lens to detector and processing;
photodetector(s);
signal processing.

The chip would include a one or more light sources and one or more photodetectors.

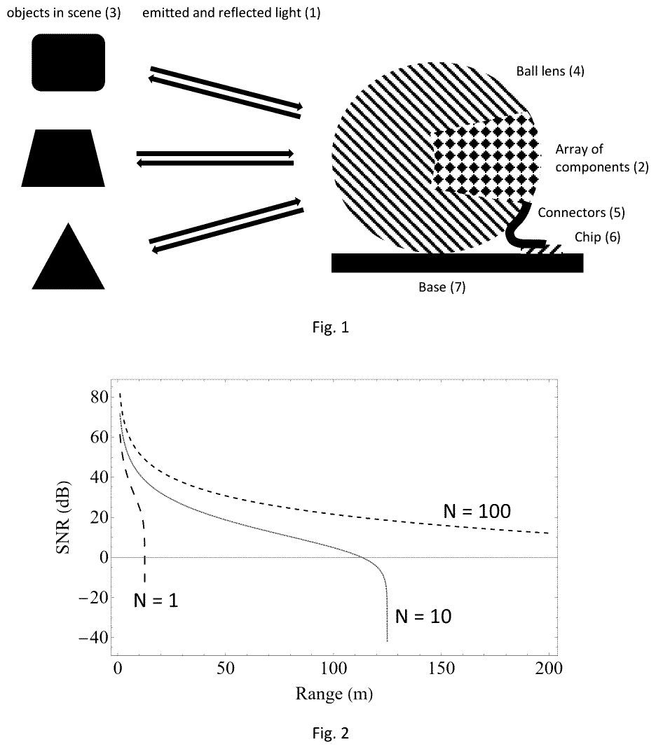

An additional light coupler could be required for coupling light from a waveguide to the chip. One can use gratings as light couplers. FIG. 1 shows the concept of a ball lens LiDAR device. Light (1) is emitted from (or through) an array of components (2). Some of this light reflects off objects (3) in the vicinity and reenters the ball lens (4), which focuses it back on the array of components. This array serves either to detect the light directly, or route it to a photodetector. A spacer may be needed between the ball lens and the array, depending on the refractive index of the ball lens and the particular design. Electrical and/or optical connectors (5) bring signals and/or power to/from to the light generating and signal processing chip (6) to the array. A base (7) supports the assembly.

The ball lens LiDAR has several potential advantages over conventional scanning LiDARs. Using a large ball gives a large area for light collection. The spherical geometry allows for a wide angular field of view (FOV). The use of multiple beams simultaneously means that scanning is not required.

Moreover, this optical engine ability to probe multiple directions at the same time would permit more optical power to be transmitted simultaneously on multiple laser beams, thus significantly boosting SNR, while still maintaining the requirements of eye safety. Although the emitter array may possess M elements, it will be understood to those skilled in the art that simultaneous multiple beams consists of any number between 2 and M. Furthermore, a first group of N<N emitters may be operated at the same time for a given period of time, A second group of N emitters may be operated in a period of time following the first group of N emitters. A third group of N emitters may be operated in a period of time prior to the first group of N emitters. The collection of emitters and their corresponding angles form a sequential spatial pattern that may repeat in accordance with the frame rate. For example, N may be equal to 100 and the array may total N=480,000. Therefore, the sequence consists of 480,000/100=4800 temporal units. For a frame rate of 25 Hz, the sequence repeats every 1/25 Hz=0.04 seconds. Each group N, therefore can be allocated up to 0.04 s/4800=8.33 μs per frame.

### Performance Modeling

The performance of an automotive LiDAR may be simulated using the LiDAR equation:

$${P}_{R} ( θ ) = {P}_{T} {η}_{R} {T}_{atm} σ {A}_{R} \overline{{I}_{R}} ( θ ) \qquad ( 1 )$$

where the variables are defined in Table 1 below. I̅_̅{̅R̅}̅ is a normalized intensity distribution at the receiver end (units of m⁻²). For scattering from a small spherical object, for example, this would give I̅_̅{̅R̅}̅=(2πR²) where R is the distance from the receiver to the target. Assuming Lambertian scattering (I(θ)=Iₙ cos(θ)), the quantity P_{T}I̅_̅{̅R̅}̅ can be found by integrating I(θ) over the surface area of a sphere,

$${P}_{T} = 2 π {R}^{2} {\int }_{0}^{π / 2} {I}_{n} cos ( θ ) sin ( θ ) d θ = π {R}^{2} {I}_{n} \qquad ( 2 )$$

and substituting back into Eqn. (1) one can arrive at

$${P}_{R} ( θ = 0 ° ) = \frac{{P}_{T}}{π {R}^{2}} {η}_{R} {T}_{atm} σ {A}_{R} = {P}_{T} {η}_{R} {T}_{atm} σ \frac{{A}_{R}}{π {R}^{2}} . \qquad ( 3 )$$

The scattering probability can be broken down into a product of two terms. The first is the target reflectivity, Γ_{R} and the second is the spatial overlap between the beam and the target. This can be expressed as

$$σ = {Γ}_{R} \frac{{A}_{T}}{{A}_{B}} \qquad ( 4 )$$

where the definitions can once again be found in Table 1. Substituting Eqn. (4) into Eqn. (3) gives the final LIDAR equation for a Lambertian target as

$${P}_{R} = {P}_{T} {η}_{R} {T}_{atm} {Γ}_{R} \frac{{A}_{T}}{{A}_{B}} \frac{{A}_{R}}{π {R}^{2}} . \qquad ( 5 )$$

This can be further simplified if the following substitutions can be made. First, the beam area at the target is assumed to be A_{B}=π(Rϕ/2)² where the quantity Rϕ/2 is the radius of the beam at the target. Second, the target area is taken to be A_{T}=wR ϕ (assuming that the target's height is greater than the beam width). In that case, A_{T}/A_{B}=4w/πR ϕ. Substituting this result into Eqn. (5) we arrive at

$${P}_{R} = {P}_{T} {η}_{R} {T}_{atm} {Γ}_{R} \frac{4 w}{π R ϕ} \frac{{A}_{R}}{π {R}^{2}} = {P}_{T} {η}_{R} {T}_{atm} {Γ}_{R} \frac{4 w}{π R ϕ} \frac{π {r}^{2}}{π {R}^{2}} = {P}_{T} {η}_{R} {T}_{atm} {Γ}_{R} \frac{4}{π} \frac{w}{ϕ} \frac{{r}^{2}}{{R}^{3}} . \qquad ( 6 )$$

The signal to noise ratio (SNR) for a shot noise limited FMCW system can then be found from

$${SNR}_{dB} = 10 {Log}_{10} \frac{2 {R}_{Det} {T}_{meas}}{q} {P}_{R} . \qquad ( 7 )$$

The integration time is Tᵢₙₜ=Tₘₑₐₛ−2R/c and accounts for the delay in the start of signal accumulation from range R within each measurement time.

TABLE 1
Definition of the symbols found in the various equations. The
values used in the simulations are also provided in this table.

| Parameter | Definition | Value for Simulation |
|---|---|---|
| P_{T} | Transmitted Power | 5.0 |
| | (mW), Per Direction | |
| η_{R} | Receiver Efficiency | 1.0 |
| Tₐₜₘ | Round Trip | 1.0 |
| | Atmospheric | |
| | Transmittance | |
| σ | Probability of Scattering | Function of R |
| A_{R} | Receiver Area (cm²) | 0.79 |
| r | Radius of Receiver (cm) | 0.5 |
| R | Range (m), Distance | Function of R |
| | Between Receiver and | |
| | Target | |
| Γ_{R} | Target Power | 0.1 |
| | Reflectivity | |
| A_{B} | Beam Diameter at | Function of R |
| | Target (m²) | |
| ϕ | Beam Divergence | 1.75 |
| | (mrad), Full Angle | |
| w | Width of Target (m) | 0.2 |
| R_{Det} | Detector Responsivity | 0.8 |
| | (A/W) | |
| q | Electron Charge (C) | 1.6 × 10⁻¹⁹ |
| Tₘₑₐₛ | Measurement Time (ns) | Increments of 83.3 |
| Tᵢₙₜ | Integration Time (ns) | Function of R |

The results of the calculation for the baseline Lambertian target possessing 10% reflectivity is provided below. The receiver is assumed to have an effective pupil diameter of 1 cm for the 5 cm sphere. Since the scene possesses 480,000 points (or directions), the incremental measurement time is taken to be (1/25 Hz)/480,000=83.3 ns. In this limit, this represents the maximum integration time for each direction in the total FOV if one looks in a single direction (1 of 480,000) at any given point in time for a system operating at 25 Hz frame rate.

The advantage of the spherical lens in the LiDAR assembly is that it enables one to look in multiple, divergent directions thereby maintaining eye safety requirements. By looking in multiple, N, directions at the same time, the measurement time in each direction may be increased by a factor of up to N. FIG. 2 shows the resulting SNR calculations for N=1, N=10, and N=100. Since the integration time in the case of N=1 is short, the maximum range is limited to 12.5 m. When N=16, the full range of 200 m is reached. Beyond that point, the SNR scales approximately linearly with N.

The ball lens could:
essentially spherical or aspherical;
made from a material transparent to the light with operational wavelength (for example, infrared), which can be glass, sapphire, II-IV materials, or other materials,
may have a refractive index larger than 1.4 in visible and infrared spectra;
may have diameter less than 10 cm, preferably between 1 mm and 10 cm.
my have a refractive index which is not constant
may have coatings on the surface to control reflections

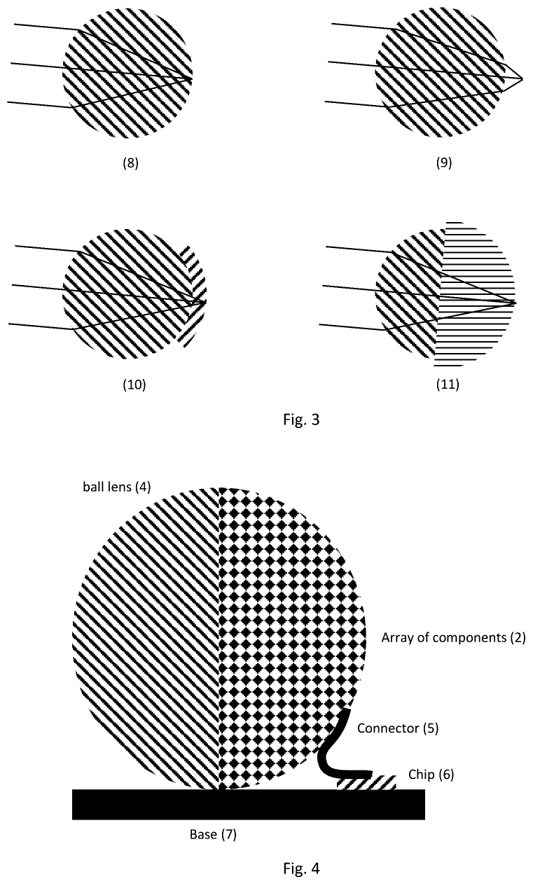

The ball lens can take several different forms, as shown in FIG. 3. If the refractive index of a ball lens n=2 at the operating wavelength, incoming paraxial rays are focused at the rear surface (8). If the refractive index n>2, paraxial rays come to a focus inside the lens. If the refractive index of a ball lens<2, paraxial rays are focused at a point behind the lens (9). Grating couplers, other light collection elements, or source/detector elements can be positioned at the foci (e.g. using standoffs). Alternatively, those elements can be placed on the surface of an intermediary piece of material, which could be of constant thickness or partitioned into multiple lenslets with the light collection elements attached (10). The lens could comprise two hemispheres, with paraxial rays focused on the back surface of the larger hemisphere (11).

The ball lens LiDAR in which array of components (2) is wrapped around a hemisphere of the ball lens (4) is shown on FIG. 4.

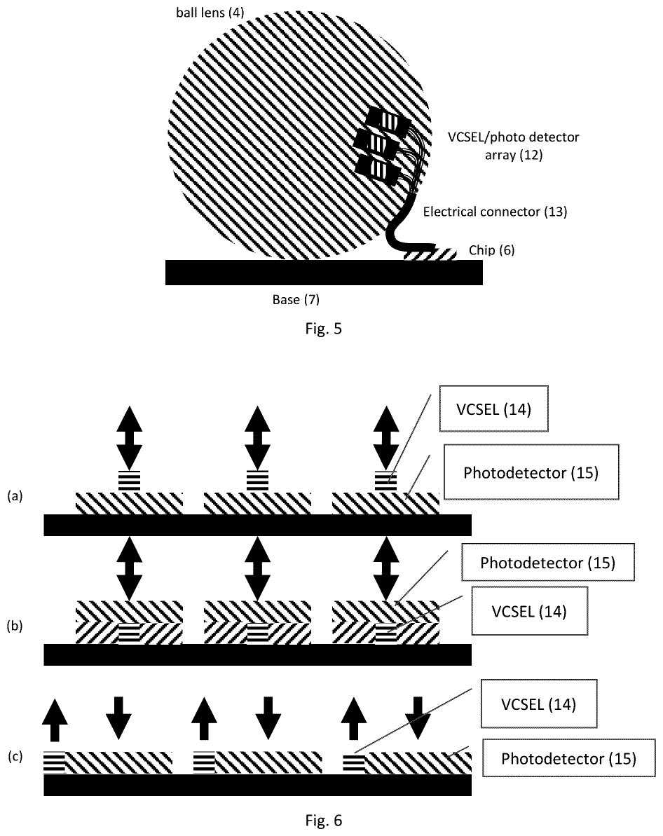

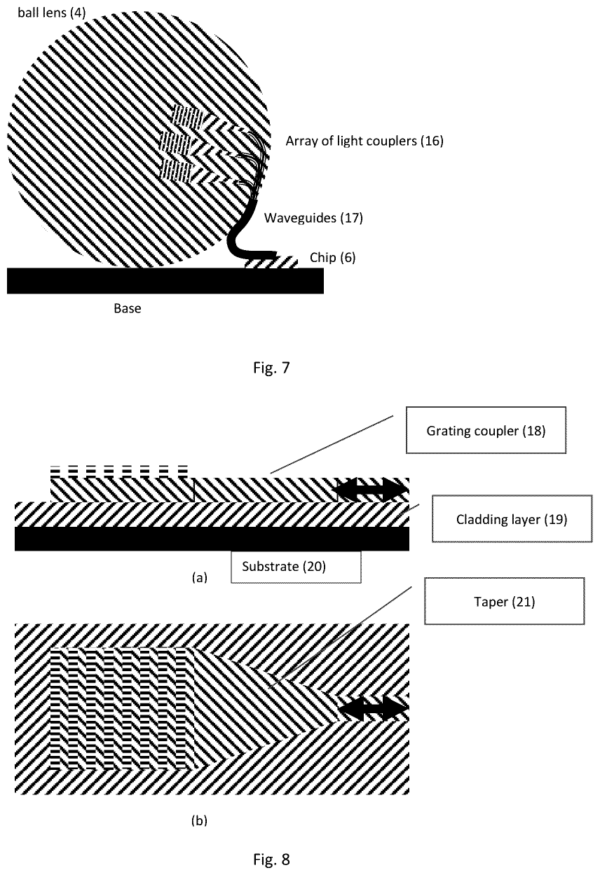

FIG. 5: The array (12) of components may consist of Vertical-Cavity-Surface-Emitting Lasers (VCSELs) and photodetectors distributed across the ball lens surface, connected to the signal processing chip (7) using electrical wires (13). There could be few different configurations of the components packaging (FIG. 6): a) VCSELs (14) on top of photodetectors (15), b) photodetectors (15) on top of VCSELs (14), and c) VCSELs (14) and photodetectors (15) side-by-side.

One could also use Vertical-External-Cavity-Surface-Emitting Lasers (VECSELs), which enables a narrower linewidth, enables wavelength tuning by modulating the phase of the region between the VCSEL and the external mirror.

FIG. 7: The array of components may consist of light couplers (16) distributed across the ball lens surface, connected to the chip using waveguides

FIG. 8a: Grating coupler (18) could be fabricated on a substrate (20) through a cladding layer (19)

FIG. 8b: A taper (21) can be used to improve the coupling efficiency from the grating into the waveguide.

Instead of gratings couplers metamaterials (metalenses) could be used as light couplers.

Some light collimation or collection components could be used between grating couplers and ball lens surface to reduce coupling losses. Such light collimation/collection components may include microlenses or metalenses or microreflectors.

Waveguides could be:
fabricated on top of a substrate;
could be fabricated inside a substrate (buried).

The substrate for waveguides could be:
rigid, with a curvature between 1 times and 2 times the lens curvature;
flexible and laminated on a ball lens surface;
could be laminated on the lens surface with less than 100% coverage;
could be attached to the ball lens surface with a gap.

Substrate with a waveguide could be positioned on the ball lens through some stand-offs or another patterned substrate.

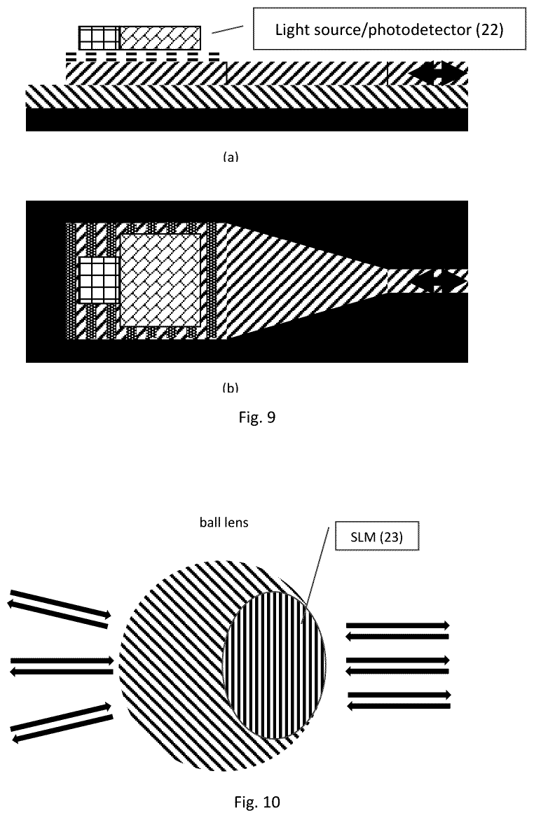

FIG. 9: Alternatively, one or more waveguides ends, instead to be coupled to the chip, could be coupled to their independent laser sources and photodetectors (22).

Frequency modulated continuous wave (FMCW) is a technique whereby a continuous wave is frequency modulated over time with a given coding scheme. In this context, the codes allow different beams (angular directions) to be distinguished from one another, and also allow the LiDAR to perform its ranging function. At least 19 bits are required to distinguish between 480K output beams (i.e. directions), A practical design can add 13 bits for the header, check sum, error correction, and to ensure the time domain codes are orthogonal enough to be distinguished easily (i.e., not mixed up in encoding/decoding). A total of 32 bits (i.e. 4 bytes) is a convenient number and would require 800 Hz modulation for a 25 Hz refresh rate.

If only N of M total output beams is operated simultaneously, then the number of codes required may be decreased.

FIG. 10: A spatial light modulator (SLM) with at least 480K pixels could be used to perform the frequency modulation for the transmitted beams. The laser beam would be spatially filtered, expanded, collimated, and then reflected from the SLM (or transmitted, depending on its type.) The modulated beam would then be directed to an array of grating input couplers to be routed to the appropriate output coupler on the ball lens. It may also be possible in principle to modulate the signals directly on an optical integrated circuit (individually, or in steps as part of a “tree” of modulators). This modulation could be accomplished e.g. with lithium niobate or other electro-optic modulation schemes.

For detection, one possibility is to mix our local laser oscillator with the received signal and detect on a 480K pixel camera. For 1550 nm, the camera would likely be cost prohibitive (˜$10˜15K), so one should consider the tradeoffs between operating at <1100 nm (lower power output is allowed due to safety limits but has a very cheap camera<$400) versus staying at 1550 nm and combining all the received signals on a single infrared photodiode ($400 but there could be complicated interference patterns from the mixing of the received signals). Combining all signals could work well because the local oscillator laser can be much stronger than any of the received signals (or even their sum), so the mixing of the local laser and one of the received directions is much stronger than the mixing of all the directions with themselves.

Other single-wavelength modulation schemes could be used, e.g. amplitude modulation (AM). There is no inherent limitation that requires the LIDAR to use FMCW.

In principle, multiple wavelengths could be used. A small number of frequencies could be used and routed to appropriate grating couplers in a manner so that the same frequencies are separated enough from each other that direction information is preserved.

SLM (23) could be laminated on the ball lens surface directly. In this configuration we have both free space uniform illumination and detection on the sphere. The light for a specific direction gets modulated both going out and coming back, thereby improving the SNR for directionality. Equally important, a single fiber input port that couples the light from the laser to optics can also collect the received signals. A circulator can then direct the received signal to the photodetector rather than back into the laser.

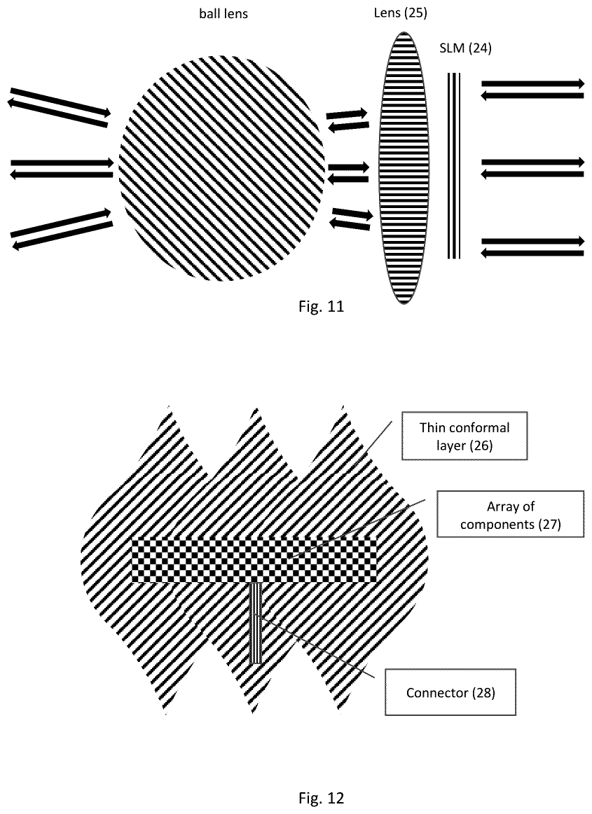

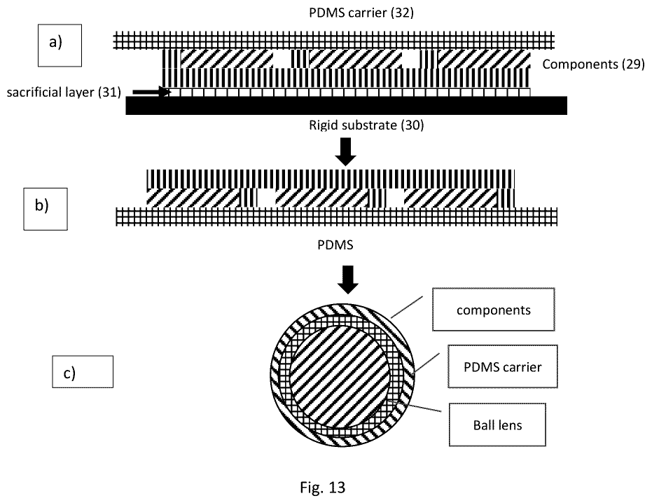

FIG. 11: SLM (24) could be a stand-alone component, and an additional lens (25) can be used to collimate light modulated by SLM on the ball lens.

There are several fabrication methods that can be used to make the component array on or transfer it to the ball lens optics.

FIG. 12 shows a schematic of a possible method for wrapping the component array around ball lens optics. The components (27) and connector (28) are fabricated on a thin conformal layer (26). The layer and component array are designed and shaped so that they can wrap conformally around the ball optics (e.g. onto spacer material or ball itself). For example, in this diagram the conformal layer (26) is cut similarly to the shape of a peeled orange.

FIG. 13: a) shows how components (29) such as VCSELs and photodetectors or waveguides and gratings can be fabricated on a rigid substrate (30), for example, semiconductor wafer, with a compatible sacrificial layer 31 (e.g. silicon dioxide for silicon-based components). The sacrificial layer can be dissolved (e.g. with hydrofluoric acid in the case of silicon dioxide) to release the components layer (b). A flexible carrier 32 (e.g. PDMS) can transfer the components to a thin conformal layer that is wrapped around the ball optics. Alternatively, this stamp (thin flexible layer, like PDMS) with the components layer can be attached to ball lens surface directly (c).

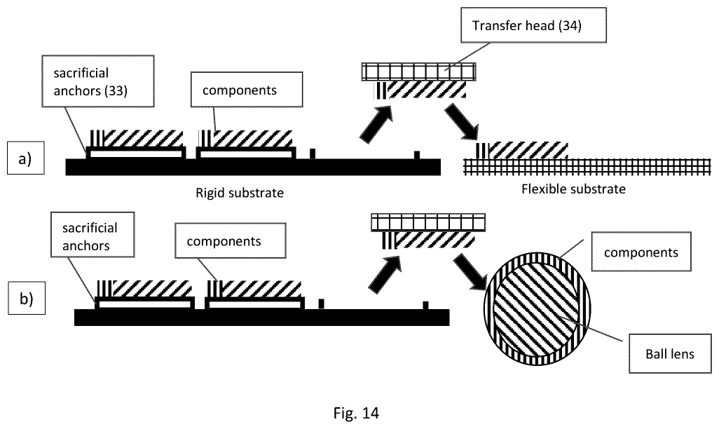

FIG. 14: Alternatively, the components could be made on substrate (e.g. rigid silicon wafer) with a sacrificial anchors (33); then during mask transfer process, the transfer head (34) initiates anchors breakage and transfer individual components to the flexible substrate (a).

Another option (b) is to move components directly to the ball lens surface, prepatterned with electrical traces, made of transparent conductive materials.

Light detectors recover distance information by demodulating the received signal with a local oscillator reference by measuring time of flight of the received signal. Detectors also recover objects relative speed information by measuring Doppler effect of the received signal.

Alternatively, both signal demodulation and time of flight are used together to improve the angular resolution, field of view, measurement range, or distance uncertainty.

The laser wavelength(s) could be tunable. Laser wavelength could be ramped up and down. Distance to the object is determined by measuring the frequency shift between when the signal is launched by the laser and when it is received by light detector. By ramping both upwards and downwards in wavelength a velocity of the target may be determined. It will be known to those skilled in the art that wavelength and frequency are related through the speed of light.

The angular direction of the object is determined by assigning the light that is emitted by the laser in each direction a unique wavelength and performing spectral decoding of the signal received by the light detector.

The laser intensity is modulated. The angular direction of the object is determined by modulating the light that is emitted by the laser in each direction with a unique time domain code and performing time domain decoding of the signal received by the light detector.

Alternatively, the angular direction of the object is determined by modulating the light that is emitted by the laser in each direction with a unique wavelength and time domain code and performing a combination of wavelength and time domain decoding of the signal received by the light detector.

The modulation, wavelength assignment, frequency ramping, and demodulation of the light generated by the laser and received by the light detector is controlled by one of an application specific integrated circuit, a field programmable gate array, a microcontroller, or a microprocessor.

Data collected by the receiving array is processed and relayed to a driver via an optical display, such as an OLED screen or other optical projection system.

What is claimed is:

1. A light detection and ranging apparatus comprising:
a 3-dimensional lens,
one or more substrates having one or more waveguides coupled to the lens,
one or more light detectors coupled to the waveguides, and
one or more light sources coupled to the waveguides.

2. An apparatus of claim 1, wherein the lens is essentially spherical

3. An apparatus of claim 1, wherein the substrate also has one or more light coupling devices coupled to the waveguide

4. An apparatus of claim 3, wherein each light coupling device has light coupling characteristics, which depends on the position of light coupling device on the lens surface

5. An apparatus of claim 3, wherein the light coupling device is grating

6. An apparatus of claim 1, wherein the light source is coherent laser

7. An apparatus of claim 1, wherein the lens is used to transmit or receive light in more than one angular range simultaneously

8. An apparatus of claim 1, wherein at least one of the light sources outputs a continuous wave signal whose frequency is modulated

9. An apparatus of claim 1, wherein at least one of the detectors recovers distance information by demodulating the received signal with a local oscillator reference

10. An apparatus of claim 1, wherein the laser frequency is ramped up and down, and at least one of the detectors recovers objects relative speed information by measuring Doppler effect of the received signal

11. An apparatus of claim 1, wherein the distance to the object is determined by measuring the frequency shift between when the signal is launched by the light source and when it is received by light detector.

12. An apparatus of claim 1, wherein the angular direction of the object is determined by assigning the light that is emitted by the light source in each direction a unique wavelength and performing spectral decoding of the signal received by the light detector.

13. An apparatus of claim 1, wherein the light source intensity is modulated, and the angular direction of the object is determined by modulating the light that is emitted by the light source in each direction with a unique time domain code and performing time domain decoding of the signal received by the light detector.

14. An apparatus of claim 1, wherein the angular direction of the object is determined by modulating the light that is emitted by the light source in each direction with a unique wavelength and time domain code and performing a combination of wavelength and time domain decoding of the signal received by the light detector.

15. An apparatus of claim 1, wherein the modulation, wavelength assignment, frequency ramping, and demodulation of the light generated by the light source and received by the light detector is controlled by one of an application specific integrated circuit, a field programmable gate array, a microcontroller, or a microprocessor.

16. An apparatus of claim 1, wherein waveguides are fabricated on a thin flexible substrate, which is wrapped around the lens

17. An apparatus of claim 1, wherein waveguides are fabricated on a separate substrate, and then transfer printed on the lens

18. An apparatus of claim 1, wherein waveguides are fabricated on a separate substrate, and then transfer-printed on the flexible substrate, which is then wrapped around the lens

19. A light detection and ranging apparatus comprising:
a 3-dimensional lens,
three or more light sources coupled to the lens, and
three or more light photo detectors coupled to the lens.

20. A light detection and ranging apparatus comprising:
a 3-dimensional lens,
one or more light sources,
one or more spatial light modulators (SLM), and
one or more light detectors.
